(19) United States
(12) Patent Application Publication
(10) Pub. No.: US 2021/0380317 A1
(43) Pub. Date: Dec. 9, 2021

(54) Caps with safety function for prevention of excessive pressure

(71) Applicant: LANXESS Deutschland GmbH, Cologne (DE)

(72) Inventors: Erasmus Vogl, Bergisch-Gladbach (DE); Marcus Taupp, Odenthal (DE)

(73) Assignee: LANXESS Deutschland GmbH, Cologne (DE)

(21) Appl. No.: 17/339,943

(22) Filed: Jun. 5, 2021

(30) Foreign Application Priority Data
Jun. 5, 2020 (EP) 20178455.0

(51) Int. Cl. B65D 51/16; B65D 43/02

(52) U.S. Cl. CPC B65D 51/1661; B65D 43/0231

(57) ABSTRACT

The invention relates to a cap for closing containers comprising at least one mesh, one foamed polymer and at least one further polymer, and to containers equipped with the cap of the invention.

The invention relates to a cap for closing containers comprising at least one mesh, one foamed polymer and at least one further polymer, and to containers equipped with the cap of the invention.

The intermediate users or end users of closed, in particular opaque, but also transparent, containers of the type used by way of example for the transport and storage of chemicals often wish to avoid any possible occurrence of excessive pressure in the containers. Excessive pressure can in particular arise if the substances are stored for a prolonged period or if there is a possibility that storage has been impaired by exposure to increased temperatures.

Instances of the above that are of decisive importance in relation to safety are those in which, for example, there can be resultant undesired changes in the container during the storage period or during transport. By way of example, there are many chemicals or substance mixtures that are susceptible to decomposition, with the associated possibility of emission of gaseous substances. Another known possibility is dissociation of the substances or substance mixtures themselves into substances that are gaseous under standard conditions. The resultant gases cannot escape, because the containers must be leakproof, for example in order to eliminate risk during transport. There is therefore the possibility that in certain situations the accumulated gases will increase the internal pressure within the container. The uncontrolled and unknown internal pressure then leads to a number of undesired effects.

By way of example, sudden depressurization occurs on opening. A possible result of this is in turn, if the substance present in the container is a liquid, it is concomitantly released and is unintentionally discharged into the environment and contaminates people and their surroundings.

Another possibility is that, as a result of the unintended spontaneous expansion of the accumulated gases during the opening procedure, an object, for example the closure itself, is subjected to a high degree of acceleration and causes injury to persons, or damage to objects, in the surroundings.

Another possibility is that, as a result of the internal pressure generated, a liquid present in the container has undergone a high degree of saturation with gas. This can by way of example lead to sudden foaming with forceful discharge of the substance as a result of the depressurization during opening.

Another possibility is that, even without the opening procedure, the internal pressure generated has an adverse effect on the mechanical stability of the container and of the respective packaging. The container can undergo undesirable deformation, or indeed can burst. The mechanical acceleration of the fragments during bursting can cause further injuries or damage; in the case of glass containers and resultant glass splinters, for example, this can vary easily lead to a more advanced and serious level of injuries to persons.

Bursting discs are the simplest device known from the prior art for easy and reliable avoidance of excessive pressure. These are marketed in a very wide variety of embodiments, for example by Fike Deutschland, Innstrasse 28, 68199 Mannheim. It is unfortunate here that when increased pressure arises the integrity of the containers is sacrificed, because the discs yield and fracture. There is therefore the risk that the chemical contents, which may be toxic, are released. Production of bursting discs is moreover complicated. Bursting-disc incorporation into existing packaging solutions is moreover often very complicated, and for cost-related reasons is not commercially available for many of the bottle-type vessels used for liquids with screw cap.

For larger containers, for example tanks, the prior art discloses overpressure valves which permit safe release of pressure without sacrificing the integrity of the containers. However, for reasons related to design, such overpressure valves are not known for smaller vessels, for example transparent bottles made of polyethylene terephthalate with capacity 250, 330, 500, 1000 or 2000 ml, of the type used in the drinks industry, because these are closed only with simple screw caps made of polyethylene or polypropylene, and these cannot easily be integrated into a design involving overpressure valves. Equally, there are also no simple solutions with overpressure valves known for aluminium bottles or glass bottles with screw closure made of plastic.

U.S. Pat. No. 4,121,728 discloses a venting liner made of foamed polymers and of two impermeable plastics layers whose surface is structured and can by way of example have indentations. These laminated plastics bodies are then punched to give discs and are applied in a closure cap. In the event of excessive pressure, release is now achieved in that cavities passing through the impressed structures have been produced, and these are utilized for dissipating pressure and lead to pressure equalization by way of the screw thread. This type of ventilation is suitable only for releasing relatively high pressures. The production of the plastics layers moreover requires technically complicated processes, and is therefore uneconomic.

The above lead to the object of finding a closure system that would permit escape of excessive pressure without changing the design of existing bottles that are made of plastic, glass or metal and that are closed with screw closures in a manner that prevents leakage of liquids.

Surprisingly, a closure system has now been found which can overcome the disadvantages of the prior art without use of additional components that are technically complicated and difficult to handle. In particular, the design can provide the particularly important feature of adaptation to the required pressure conditions.

The invention therefore provides a cap with screw thread for closing a container, comprising at last one mesh applied in the cap to the internal wall of the cap, and comprising at least one foamed polymer layer applied to the mesh and comprising at least one further polymer layer which has been applied on the foamed polymer layer and which closes the container aperture.

The cap preferably consists of polymers or metal. Stainless steel and aluminium are preferably used as metals of which the caps can consist. Polyethylene terephthalate (PET), polypropylene (PP) or polyethylene (PE) or mixtures of these polymers are preferably used as polymers of which the caps can consist. With particular preference, the cap consists of optically transparent, opaque or coloured polyethylene terephthalate (PET), polypropylene (PP) or polyethylene (PE) or mixtures of these polymers. It is even more preferable that the cap consists of polyethylene. Production of caps of the type mentioned is known to the person skilled in the art. By way of example, caps made of polyethylene terephthalate (PET), polypropylene (PP) or polyethylene (PE) are commercially available.

The cap per se, without the insert of the invention with at least one mesh applied in the cap to the internal wall of the cap, and comprising at least one foamed polymer layer applied to the mesh and comprising at least one further polymer layer which has been applied on the foamed polymer layer and which closes the container aperture, is a commercially available cap or, respectively, a lid with screw closure. The expressions “cap with screw closure” and “lid with screw closure” are used synonymously for the process of the invention.

The cap has a screw thread with which it can be screwed onto the aperture of the container.

The cap can preferably also have been modified by safety rings. Safety rings serve to indicate a first opening of a bottle, and are known, for example, from WO-A-9213773. Safety rings preferably consist of the material of which the cap also consists.

The term containers preferably applies to bottles. The volume of the containers is preferably 250, 330, 500, 1000, 2000, 6000, 10 000 ml or 40 000 ml. With particular preference, the volume of the containers is 2000 ml to 40 000 ml. The containers can consist of polymers, for example preferably polyethylene terephthalate, polypropylene or polyethylene, or of metal, for example preferably aluminium and stainless steel, or of glass. With particular preference, the container consists of at least 95% by weight of aluminium, or of glass, based on the total weight of the container without closure. The invention likewise provides the container comprising the cap of the invention. The container with the cap of the invention is preferably used for the transport and the storage of chemicals, with particular preference for the transport and storage of liquid dimethyldicarbonate. It has moreover been found that dissipation of pressure by the cap of the invention is particularly successful specifically in the case of containers that are only partially filled.

The invention therefore likewise encompasses a container with the cap of the invention where the container is partially or entirely filled with liquid dimethyldicarbonate. The container is preferably partially filled.

The mesh can either be dimensionally stable or else have elastomeric properties. It can by way of example also consist of foamed polymers.

The mesh preferably consists of polymers or metal. Stainless steel and aluminium are preferably used as metals of which the meshes can consist. Polyethylene terephthalate (PET), polypropylene (PP), polyethylene (PE), polycarbonate or polytetrafluoroethylene (PTFE) or mixtures of these polymers are preferably used as polymers of which the meshes can consist. With particular preference, the mesh consists of polypropylene (PP) or polyethylene (PE) or mixtures of these polymers.

The shape of the mesh filaments of the mesh can be rectangular or round, or they can have any other shape. The shape of the mesh filaments of the mesh is preferably round.

The mesh filaments can preferably be arranged perpendicularly to one another, but can also exhibit other angles, preferred examples being 55° to 65°, 85° to 95° or 110° to 130°. With particular preference, the mesh filaments are arranged at an angle of 85° to 95° to one another.

The mesh filaments of the mesh preferably have a width of 0.2 mm to 5 mm and a height of 0.2 mm to 5 mm, in the event that they are in essence rectangular mesh filaments. With particular preference, the mesh filaments of the mesh have a width of 0.5 mm to 2 mm and a height of 0.5 mm to 2 mm, in the event that they are in essence rectangular mesh filaments. It is preferable that both mesh filaments have, within a margin of error of 5%, the same width and height. The mesh filaments of the mesh preferably have a diameter of 0.2 mm to 5 mm, with particular preference a diameter of 0.5 mm to 2 mm, in the event that they are in essence round mesh filaments. The separation between the mesh filaments is preferably 2 mm to 20 mm. The ratio of the diameter of the mesh filaments to the space between the mesh filaments is preferably 1:7 to 1:12. It is preferable that the mesh is a polyethylene mesh with round mesh filaments with a diameter of 2 mm and a separation of 10 mm, preferably oriented at right angles to one another.

The mesh can be produced in various ways. By way of example, meshes made of polymers can be produced by an extrusion process. Polymeric meshes can moreover be produced by a roll process using appropriately shaped rolls. Polymeric meshes can moreover be produced from a plastics layer by a milling process. A web or adhesion process is equally suitable. Meshes made of polymers are by way of example commercially available from HaGa-Welt GmbH & Co. KG, Lange Str. 5, 31171 Nordstemmen, Germany. Meshes made of metals can by way of example be produced by casting processes or wire erosion processes.

It is preferable that the mesh has a round shape, so that it can be matched, in essence with precise fit, to the internal wall of the cap. The diameter of the mesh is preferably 2 cm to 10 cm. With particular preference, the diameter of the mesh is 6.6 cm+/−0.2 cm. With particular preference, the mesh has mesh filaments with a diameter of 2 mm+/−0.1 mm with a mesh separation of 10 mm+/−0.5 mm. The mesh could have a boundary edge, so that it can form a leakproof connection to the internal wall of the cap. It is preferable that this boundary edge consists of a polymer that is the same as the polymer of which the mesh consists. It is preferable that the mesh does not have any such boundary edge.

For the purposes of the present invention, the meaning of in “essence” is that the size difference between two components to be compared is not more than 5%, preferably not more than 1%.

Suitable foamed polymers of which the foamed polymer layer can consist are preferably polypropylene, polyethylene, high-density polyethylene (HDPE), low-density polyethylene (LDPE), high-density polypropylene (HDPP), low-density polypropylene (LDPP), polyethylene terephthalate, polystyrenes, polyurethane, polycarbonate, ethylene-propylene-diene rubber (EPDM), or fluorinated foamed polymers, such as preferably fluororubber (FKM) in accordance with DIN ISO 1629 and fluororubber in accordance with ASTM D1418, polytetrafluoroethylene (PTFE), or other foamed partially fluorinated or perfluorinated hydrocarbons based on vinylidene (di)fluoride or mixtures of these foamed polymers. Polystyrene, polyethylene or polypropylene are preferably used as foamed polymers. Production of foamed polymers is known from the prior art and therefore uses known methods. With particular preference, the foamed polymer layer consists of foamed polyethylene or foamed polypropylene.

The density of the foamed polymer is preferably 45 to 450 kg/m³, with particular preference 100 kg/m³ to 250 kg/m³.

It is preferable that the shape of the foamed polymer layer is round, so that it can in essence be matched with precise fit to the mesh. The diameter of the foamed polymer layer is preferably 2 cm to 10 cm. With particular preference, the diameter of the foamed polymer layer is 6.6 cm+/−0.2 cm. The thickness of the foamed polymer layer is preferably 0.2 mm to 5 mm. With particular preference, the thickness of the foamed polymer layer is 3 mm+/−0.15 mm.

A further polymer layer is applied to the foamed polymer layer. This polymer layer preferably consists of polytetrafluoroethylene (PTFE). However, it is also possible to use other polymers. These polymers must have the property of separating the foamed polymer layer from the container contents, therefore acting as seal.

It is preferable that the shape of the further polymer layer is round, so that the said layer can be matched in essence with precise fit to the foamed polymer layer. The diameter of the further polymer layer is preferably 2 cm to 10 cm. With particular preference, the diameter of the further polymer layer is 6.6 cm+/−0.2 cm. The thickness of the polymer layer is preferably 0.01 mm to 4 mm. With particular preference, the thickness of the further polymer layer is 0.5 mm+/−0.025 mm. The polymer layer can be brought into contact with the foamed polymer layer by placement thereon, with no further fixing. It is preferable that the further polymer layer is fixed on the foamed polymer layer.

It is preferable that an adhesive is used to connect the foamed polymer layer to the further polymer layer.

Adhesives used are preferably adhesives based on cyanoacrylates, methylmethacrylates, unsaturated polyesters, epoxy resins, phenolic resins, polyimides, polysulfides, bismaleimides and 1-component and 2-component condensation-crosslinking silicones.

It is preferable that the foamed polymer layer and the further polymer layer are used in the form of composite. The composite is preferably produced via lamination of the foamed polymer layer and the further polymer layer in the presence of an adhesive. With particular preference, a cyanoacrylate adhesive is used as adhesive.

The composite is preferably placed onto the mesh.

A seal or a sealing ring can be placed between the container aperture and the polymer layer. The seal preferably consists of polyethylene. The seal preferably has a diameter that in essence is the same as the diameter of the further polymer layer. The seal preferably has a thickness that in essence is the same as the thickness of the further polymer layer. This seal is preferably likewise fixed on the further polymer layer by an adhesive. The fixing of the seal on the polymer layer and on the container aperture, in particular the edge of the container, could equally be achieved via the mechanical force that acts on closure of the container aperture by the cap, i.e. via constriction of the seal. With preference, no seal is introduced between the container aperture and the polymer layer. With preference, the polymer layer forms the closure layer of the container aperture. The polymer layer preferably serves as seal.

It is preferable that the fixing of the foamed polymer layer, of the further polymer layer and of the mesh on the container aperture is achieved via closure of the container by the cap.

It is preferable that the closure of the container by the cap of the invention is achieved with a maximal tightening torque M, where the maximal tightening torque M complies with the following: preferably 4 Nm≤M≤8 Nm, with particular preference 5 Nm≤M≤7 Nm.

Use of the cap of the invention can dissipate pressures ≥1.2 bar.

The invention is explained in more detail below with reference to the figures, without restriction of the general concept of the invention.

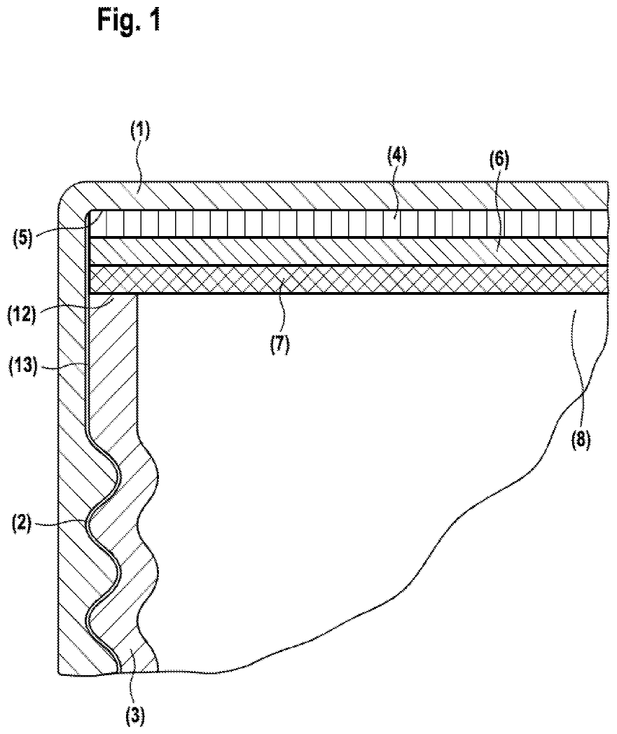

FIG. 1 shows a general structure of the cap of the invention.

FIG. 1 here shows a cap (1) of the invention with screw thread (2) for closing a container (3), comprising at least one mesh (4) applied in the cap to the internal wall (5) of the cap, and comprising at least one foamed polymer layer (6) applied to the mesh (4) and comprising at least one further polymer layer (7) which has been applied on the foamed polymer layer (6) and which closes the container aperture (8).

The container (3) is preferably closed by pressing, onto the same, the cap (1) with the mesh (4), the foamed polymer (6) and the further polymer layer (7).

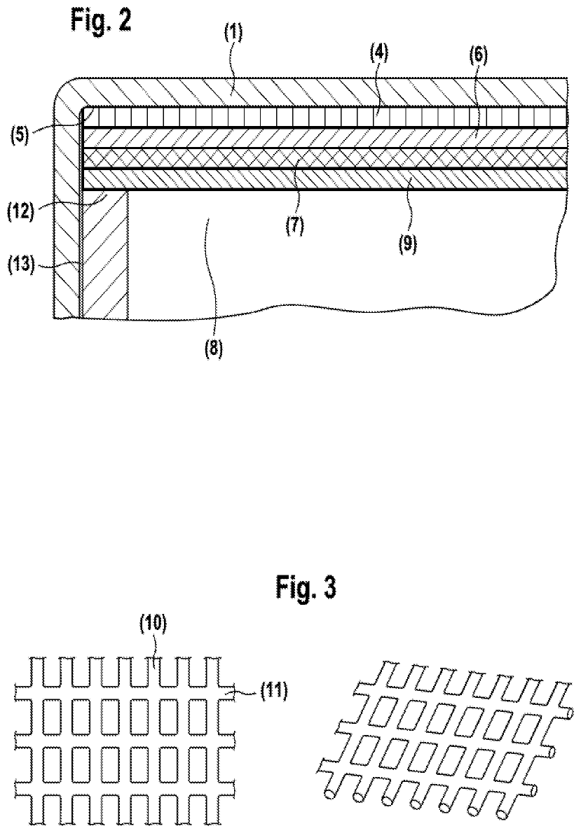

FIG. 2 shows a further embodiment of the invention, where a seal (9) is used which additionally seals the container aperture (8) at the edge (12) of the aperture. In this embodiment, the polymer layer (7) is placed onto the seal (9). It is preferable that the polymer layer (7) and the seal (9) are connected to one another. This is preferably achieved by adhesion.

By virtue of the pressure, the foamed polymer layer (6) can move into the open regions of the mesh (4). The further polymer layer (7) follows the motion of the foamed polymer layer (6) and thus releases regions at the edge (12) of the bottle aperture which permit release of pressure by way of the gap (13) between container aperture and cap.

FIG. 3 shows the mesh (4) with the mesh filaments (10) and (11).

The invention permits incorporation of excessive-pressure prevention at extremely low cost and without any structural change to the cap, merely by insertion of a mesh and of two polymers differing from one another or of a composite of these polymers. There is no need to implement any structural measures on the cap; considerable costs and resources are thus saved.

The design can provide reliable avoidance of excessive pressure, without at any juncture sacrificing the integrity of the packaging.

### EXAMPLES

### Inventive Example 1

A round mesh made of polyethylene (diameter 6.6 cm, diameter of mesh filaments 2 mm, separation between the mesh filaments in the square mesh: 10 mm) and a composite made of foamed polyethylene (PE) (thickness: 3 mm, density: 194 kg/m³, diameter: 6.6 cm) and of a polytetrafluoroethylene layer (PTFE) with a thickness of 0.5 mm (diameter: 6.6 cm) were inserted into a commercially available polyethylene closure cap of diameter 6.6 cm with screw thread. The cap moreover bore a safety ring to indicate absence of damage prior to opening.

An empty aluminium bottle with a volume of 6 l was then closed by the above cap with a tightening torque of 6.7 Nm, and the pressure within the bottle was slowly increased to 1.5 bar by adding compressed air. The pressure within the bottle was measured by a manometer integrated within the bottle. When 1.5 bar was reached, a release of pressure was observed; by virtue of the pressure, the foamed polymer layer (6) was able to move into the open regions of the mesh. The polytetrafluoroethylene layer (7) follows the motion of the foamed polymer layer (6) and thus releases regions at the edge (12) of the bottle aperture which permit release of pressure by way of the gap (13) between container aperture and cap. Within 15 minutes, the pressure decreased from 1.5 bar to 1.2 bar.

Once appropriate release of pressure has been achieved, the polymer layers again provide closure.

### Inventive Example 2

A round mesh made of polyethylene (diameter 6.6 cm, diameter of mesh filaments 2 mm, separation between the mesh filaments in the square mesh: 10 mm) and a composite made of foamed polyethylene (PE) (thickness: 3 mm, density: 194 kg/m³, diameter: 6.6 cm) and of a polytetrafluoroethylene layer (PTFE) with a thickness of 0.5 mm (diameter: 6.6 cm) were inserted into a commercially available polyethylene closure cap of diameter 6.6 cm with screw thread. The cap moreover bore a safety ring to indicate absence of damage prior to opening.

An aluminium bottle with a volume of 6 l was then closed by the above cap with a tightening torque of 6.7 Nm The bottle contained 6 kg of dimethyldicarbonate (Velcorin, Lanxesss Deutschland GmbH, batch CHWV5547, purity >99.8%). After filling and closure, the bottle was stored for 12 months at room temperature. The bottle was then stored for 6 months at 50° C. The bottle was then opened. On opening, the bottle was free from damage, and no pressure increase ≥1.2 bar could be detected. The purity of the DMDC was by this stage only 90%. By virtue of the cap of the invention, the CO₂ formed during the partial decomposition of the DMDC was able to escape.

The experiment was repeated with a 3 l glass bottle containing 3 kg of dimethyldicarbonate. Again in this case no pressure increase ≥1.2 bar could be observed on opening, and the bottle remained undamaged.

### Comparative Example 1

An aluminium bottle with a volume of 6 l was closed by a commercially available cap with screw thread, with a torque of 6.7 Nm; compressed air was used to produce a pressure of 1.5 bar, and any pressure decrease that might occur was observed over a period of 3 days. The pressure within the bottle was measured by a manometer integrated within the bottle. No release of pressure was measured.

### Comparative Example 2

The cap with inserted composite comprising foamed polyethylene (PE) (6) and polytetrafluoroethylene layer (PTFE) (7), from Inventive Example 1, but without the additional mesh (4), was used to close a 30 litre glass bottle containing 3 litres of dimethyldicarbonate and 1 litre of water, with a torque of 6.7 Nm. After 24 h of pressure increase, the glass shattered at a pressure of 10 bar.

What is claimed is:

1. Cap (1) with screw thread (2) for closing a container (3), comprising at least one mesh (4) applied in the cap to the internal wall (5) of the cap, and comprising at least one foamed polymer layer (6) applied to the mesh (4) and comprising at least one further polymer layer (7) which has been applied on the foamed polymer layer (6) and which closes the container aperture (8).

2. Cap according to claim 1, wherein within the mesh (4) the diameter of the mesh filaments, which are in essence round, is 0.2 mm to 5 mm.

3. Cap according to claim 1, wherein the foamed polymer layer (6) comprises at least one polymer selected from the group consisting of polypropylene, polyethylene, high-density polyethylene (HDPE), low-density polyethylene (LDPE), high-density polypropylene (HDPP), low-density polypropylene (LDPP), polyethylene terephthalate, polystyrenes, polyurethane, polycarbonate, ethylene-propylene-diene rubber (EPDM), or fluorinated foamed polymers, such as preferably fluororubber (FKM) in accordance DIN ISO 1629 and fluororubber in accordance with ASTM D1418, polytetrafluoroethylene (PTFE), and other foamed partially fluorinated or perfluorinated hydrocarbons based on vinylidene (di)fluoride or mixtures of these foamed polymers.

4. Cap according to claim 1, wherein the density of the foamed polymer layer (6) is 45 to 450 kg/m³.

5. Cap according to claim 1, wherein the polymer layer (7) consists of polytetrafluoroethylene.

6. Cap according to claim 1, wherein an adhesive is used to connect the foamed polymer layer (6) to the polymer layer (7).

7. Cap according to claim 6, wherein adhesives used are based on at least one of cyanoacrylates, methylmethacrylates, unsaturated polyesters, epoxy resins, phenolic resins, polyimides, polysulfides, bismaleimides and 1-component and 2-component condensation-crosslinking silicones and glutine glue or mixtures of these adhesives.

8. Cap according to claim 1, wherein the mesh (4) consists of polypropylene (PP) or polyethylene (PE) or mixtures of these polymers.

9. Cap according to claim 1, wherein a polyethylene seal is used as seal on an edge (12) of the container aperture (8).

10. Cap according to claim 1, wherein the cap (1) consists of polyethylene terephthalate (PET), polypropylene (PP) or polyethylene (PE) or mixtures of these polymers.

11. Container comprising the cap according to claim 1.

12. Container according to claim 11, wherein the container has been at least partially filled with liquid dimethyldicarbonate.

13. Container according to claim 1, wherein the maximal tightening torque M used to close the cap is 4 Nm≤M≤8 Nm.

14. Container according to claim 11, wherein the aluminium content of the container is ≥95% by weight, based on the total weight of the container without cap.
